(19) United States
(12) Patent Application Publication
(10) Pub. No.: US 2024/0300712 A1
(43) Pub. Date: Sep. 12, 2024

(54) Cold Chain Packaging

(71) Applicant: 3M INNOVATIVE PROPERTIES COMPANY, St. Paul, MN (US)

(72) Inventors: Ignatius A. Kadoma, Cottage Grove, MN (US); Milind B. Sabade, Woodbury, MN (US); Ryan J. Rogers, Shoreview, MN (US); Kenneth P. Morris, Cottage Grove, MN (US); Scott M. Tapio, Falcon Heights, MN (US); Delony L. Langer-Anderson, Hugo, MN (US); Sithya S. Khieu, Eden Prairie, MN (US)

(21) Appl. No.: 18/258,338

(22) PCT Filed: Apr. 14, 2021
(86) PCT No.: PCT/IB2021/053087

§ 371 Date: Jun. 20, 2023

Related U.S. Application Data
(60) Provisional application No. 63/199,350, filed on Dec. 21, 2020.

(51) Int. Cl. B65D 65/46; B65D 65/40; B65D 81/38

(52) U.S. Cl. CPC B65D 65/466; B65D 65/40; B65D 81/38

(57) ABSTRACT

The present disclosure relates generally to cold chain packaging, cold chain packaging articles and devices, and methods of making and using the cold chain packaging, articles, and devices. The cold chain packaging, articles, and devices of the present disclosure include (1) one or more “Phase Change Materials” (PCMs); and (2) one or more protective coverings that are adjacent to the PCM and that protect the PCM and/or item to be shipped from the environment during shipping and transport.

### TECHNICAL FIELD

The present disclosure relates generally to cold chain packaging, cold chain packaging articles and devices, and methods of making and using the cold chain packaging, articles, and devices.

### BACKGROUND

A fundamental pillar of public health is the availability of vaccines and pharmaceuticals to prevent and treat disease. The ability to maintain temperature of vaccines and pharmaceuticals from the manufacturer to the end user (often referred to as the “cold chain”) helps to assure the viability of the vaccines and pharmaceuticals. Maintaining the vaccine and pharmaceutical cold chain is an essential part of a successful immunization program. Vaccines are biological products that lose potency, or are even destroyed, with each exposure to temperatures below or above the recommended range. According to the National Institute of Health, good distribution and storage practices clearly state that temperature-sensitive products should be stored, handled and distributed with great care throughout the distribution network. Temperature monitoring is required throughout the entire supply chain process. The Centers for Disease Control and Prevention (CDC) cites that a quarter of vaccines are degraded by the time they arrive at their destination due to excessive heat exposure during transport¹. According to the World Health Organization (WHO)², freezing temperatures were found in nearly 17% of vaccines during transport in developed countries. All these errors reduce the scale of deployment and effectiveness of the vaccines and pharmaceuticals being shipped. ¹ Vaccine Storage and Handling Toolkit. U.S. Dept. of Health & Human Services. Centers for Disease Control & Prevention² Freezing temperatures in vaccine cold chain. National Institute of Standards and Technology

### SUMMARY

The inventors of the present disclosure recognized that existing solutions (cold packs, ice and dry ice) fail to provide temperature control that is precise, tunable, long-lasting, and/or resilient. For example, gel packs can only maintain temperature around 0° C., and dry ice can maintain temperature around −65° C. Additionally, there are limitations regarding air transport for packages that include dry ice due to CO₂ release. As such, the inventors of the present disclosure sought to create improved cold chain packaging, articles, and devices.

The present disclosure describes and claims cold chain packaging, articles, and devices as well as methods of making and using the cold chain packaging, articles, and devices. The cold chain packaging, articles, and devices of the present disclosure are cost-effective and improve upon existing options. The cold chain packaging, articles, and devices can ensure proper temperature bands are maintained for vaccines and pharmaceuticals while also producing significant savings in direct and indirect costs of transportation and potential spoilage. In some embodiments, the cold chain packaging, articles, and devices are compostable.

The cold chain packaging, articles, and devices of the present disclosure include (1) one or more “Phase Change Materials” (PCMs); and (2) one or more protective coverings that are adjacent to the PCM and that protect the PCM and/or an item in the packaging (such as, for example, a vaccine or pharmaceutical) from the environment during shipping and transport.

PCMs are substances with a high heat of fusion that, when melting or solidifying, can store and release large amounts of energy at a certain temperature (that is, undergoing a phase change). During a phase change such as melting or freezing, molecules rearrange themselves and cause an entropy change that results in the absorption or release of latent heat. Throughout a phase change, the temperature of the material itself remains constant. Some exemplary common PCMs include salts, hydrated salts, fatty acids, and paraffins. Such PCMs, suitably packaged, may be used as thermal devices. Unlike dry or wet ice, however, most PCMs are not readily adaptable for shipping and transportation applications by themselves. They must be paired with an appropriate protective covering. Together, the PCM and protective covering form a packaging construction which will be able to protect the article to be transported at the desired temperature.

In some embodiments, the one or more PCMs have tunable physical properties such as: target temperature, density, viscosity, thermal conductivity, thermal diffusivity, specific heat and/or latent heat. In some embodiments, the PCM and/or cold chain packaging is at least one of compostable, fire-resistant, shape-stable, non-toxic, and/or non-corrosive. In some embodiments, the PCM is bio-based. In some embodiments, both the protective covering and PCM are compostable. In some embodiments, the one or more PCMs are highly tunable (anywhere between −135° C. and 175° C.), with a 120-hour temperature control range. In some embodiments, the one or more PCMs can deliver stable temperatures down to −100° C. and/or maintain typical vaccine temperature of 2 to 8° C.

The cold chain packaging, articles, and devices of the present disclosure provide precise temperature control, which allows for the safe transport of vaccines and pharmaceuticals year-round, without active refrigeration.

### BRIEF DESCRIPTION OF DRAWINGS

The disclosure may be more completely understood by the accompanying drawings in which are shown by way of illustration several specific embodiments. It is to be understood that other embodiments are contemplated and may be made without departing from the scope or spirit of the present disclosure.

FIG. 1 is a cross-sectional view of an exemplary protective covering of a type generally described herein.

FIG. 2 is a cross-sectional view of an exemplary protective covering of a type generally described herein.

FIG. 3 is a cross-sectional view of an exemplary protective covering of a type generally described herein.

FIG. 4 is a cross-sectional view of an exemplary protective covering of a type generally described herein.

FIG. 5 is a cross-sectional view of an exemplary protective covering of a type generally described herein.

### DETAILED DESCRIPTION

Various embodiments and implementations will be described in detail. These embodiments should not be construed as limiting the scope of the present application in any manner, and changes and modifications may be made without departing from the spirit and scope of the present disclosure. For example, the cold chain packaging, articles, and devices of the present disclosure will be discussed with respect to use with vaccines and/or pharmaceuticals, but they may be used to package any desired material or item. Use with vaccines and/or pharmaceuticals is merely exemplary. As such, only some end uses have been discussed herein, but end uses not specifically described herein are included within the scope of the present application. As such, the scope of the present disclosure should be determined by the claims.

The cold chain packaging, articles, and devices of the present disclosure include (1) one or more “Phase Change Materials” (PCMs); and (2) one or more protective coverings that are adjacent to the PCM and that protect the PCM and/or an item in the packaging (such as, for example, a vaccine or pharmaceutical) from the environment during shipping and transport.

As used herein, the term “packaging” refers to articles or devices or items that are used to transport, store, or protect goods. Some exemplary packaging includes, for example, mailers, envelopes, bags, and pouches.

### Exemplary Protective Coverings

Desired protective coverings of the present disclosure enclose or encapsulate and protect the PCM and/or article being packaged. The protective covering may be a single layer of material or multiple layers of material. Where multiple layers of materials are used, the multiple layers may be bonded or adhered in any suitable way including, for example, heat-sealing (e.g., induction welding or impulse sealing) or adhesive sealing. The protective coverings may have one or more of the following qualities.

In some embodiments, high durability and/or puncture resistance are important characteristics of a protective covering such that the covering maintains its integrity in a shipping environment where the package may be roughly handled or may encounter sharp or jagged edges of products or other packaging. These features also aid in preventing leakage of the phase change material(s) such that the phase change material could leak out of the package, and thus be unable to keep the temperature constant, or the phase change material(s) could come into contact with the shipped product, potentially reducing its efficacy or polluting it. As such, in some embodiments, the protective covering has a sufficiently high tensile strength. In some embodiments, the protective covering has a tensile strength of between about 1.0×10⁵ N/m² to about 9.0×10⁷ as measured according to ASTM D882. In some embodiments, the protective covering has a tensile strength of between about 1.0×10⁶ N/m² to about 2.0×10⁷ as measured according to ASTM D882.

In some embodiments, the protective covering has a low thickness to reduce weight and/or to aid in manufacturing and/or cost. In some embodiments, the thickness of the protective covering is between about 100 micrometers and about 250 micrometers.

In some embodiments, the protective covering has sufficient elongation to provide adequate containment of the one or more phase change materials and the item to be transported during shipping. In some embodiments, the elongation of the protective covering is between about 0.5% and about 80% as measured according to ASTM D882. In some embodiments, the elongation of the protective covering is between about 1% and about 41% as measured according to ASTM D882.

In some embodiments, the protective covering is compostable. The term “compostable” refers to materials, compositions, or articles that meet the standard ASTM D6400 or ASTM D6868. It should be noted that those two standards are applicable to different types of materials, so the material, composition, or article need only meet one of them, usually whichever is most applicable, to be “compostable” as defined herein. Particularly, compostable materials, compositions, or articles will also meet the ASTMD5338 standard. Particularly, compostable materials, compositions, or articles will also meet one or more of the EN 12432, AS 4736, or ISO 17088 standards. More particularly, compostable materials, compositions, or articles will also meet the ISO 14855 standard. It should be noted that the term “compostable” as used herein is not interchangeable with the term “biodegradable.” Something that is “compostable” must degrade within the time specified by the above standard or standards into materials having a toxicity, particularly plant toxicity, that conform with the above standard or standards. The term “biodegradable” does not specify the time in which a material must degrade nor does it specify that the compounds into which it degrades pass any standard for toxicity or lack of harm to the environment. For example, materials that meet the ASTM D6400 standard must pass the test specified in ISO 17088, which addresses “the presence of high levels of regulated metals and other harmful components.” whereas a material that is “biodegradable” may have any level of harmful components.

Additional characteristics that are important include one or more of resistance to leakage, breathability (minimal breathability may be preferred), freeze/thaw performance (the ability to maintain integrity of the package over a wide range of temperatures, as stated herein), thermal formability, resistance to staining, resistance to odor, and/or water resistance.

The protective coverings described herein include (1) a bio-based polymer and (2) a bio-based hydrophobic agent. As used herein, the term “hydrophobic” in reference to an agent, refers to an agent that exhibits an advancing water contact angle of at least 90°.

Exemplary bio-based polymers include polybutylene succinate (PBS), poly(lactic acid) (which is sometimes known as PLA, and as used herein is intended to encompass both poly(lactic acid) and poly(lactide)), poly(glycolic acid) (which as used herein is intended to encompass both poly(glycolic acid) and poly(glycolide)), poly(caprolactone), poly(lactide-co-glycolide), copolymers of two or more of lactic acid, glycolic acid, and caprolactone, polyhydroxyalkanoate (PHA), polyester urethane, degradable aliphatic-aromatic copolymers, poly(hydroxybutyrate) (PHB), copolymers of hydroxybutyrate and hydroxy valerate, poly(ester amide), polyhydroxy hexanoate (PHH), cellulosic ester, and cellulose.

In some embodiments, the bio-based polymer is in the form of a nonwoven sheet. Spun bonding is one particularly useful method of manufacturing nonwoven sheets of such materials. Exemplary spun bonding processes that produce nonwovens useful for the packaging articles described herein are described in U.S. Pat. No. 3,803,817, but other processes may also be employed. Some additional exemplary suitable nonwovens include those that are spunbonded, melt-blown, spunlace, air laid, wet-laid or carded materials, and combinations thereof.

Exemplary bio-based hydrophobic agents include plant-based waxes and plant-based oils. Exemplary bio-based hydrophobic agents include, but are not limited to, ethylene bis(stearamide) (EBS), castor wax, palmitic acid, linoleic acid, arachidic acid, palmitoleic acid, butyric acid, stearic acid, and triglyceride. In some embodiments, the protective covering includes between 0.5 and 15 polymer weight percent of the bio-based hydrophobic agent. In some embodiments, the protective covering includes more than 0.5, 1.0, 1.5, 2.0, 2.5, 3.0, 3.5, 4.0, 4.5, or 5.0 polymer weight percent of the bio-based hydrophobic agent. In some embodiments, the protective covering includes less than 15, 14, 13, 12, 11, or 10 polymer weight percent of the bio-based hydrophobic agent.

Some exemplary protective coverings that satisfy one or more of the above characteristics are as follows:

### Embodiment 1

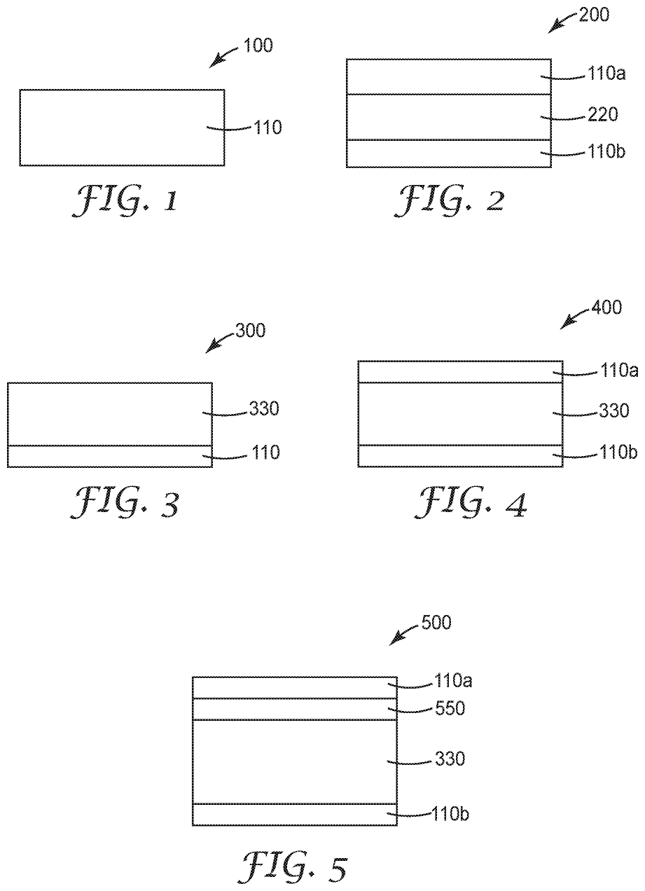

FIG. 1 shows one exemplary embodiment of an exemplary protective covering of the present disclosure. Protective covering 100 includes a protective covering layer 110 including (1) a bio-based polymer and (2) a bio-based hydrophobic agent. In one exemplary implementation of this embodiment, the bio-based polymer is PBS and the bio-based hydrophobic agent is castor wax. In some embodiments, the thickness of layer 110 is between about 12.7 micrometers and about 25.4 micometers.

Protective covering layer 110 can include other components. For example, protective layer 110 can include colorants, pigments or dyes, and may specifically include bio-based or compostable pigments and dyes. Some exemplary pigments or dyes that may be used include PLA masterbatch colorings available from Clariant Corp. (Minneapolis, MN, USA) under the OM or OMB lines of products or those available from Techmer PM LLC (Clinton, TN, USA) under the PLAM or PPM lines of products. Typically, when colorants, pigments, or dyes are included, they are blended with the other layer components at an amount of 0.5%-5% by weight.

### Embodiment 2

FIG. 2 shows another exemplary embodiment of an exemplary protective covering of the present disclosure. Protective covering 200 includes a nonwoven layer 220 between two layers of protective covering layer 110 of FIG. 1, shown in FIG. 2 as 110a and 110b. Layers 110a and 110b include (1) a bio-based polymer and (2) a bio-based hydrophobic agent. Layers 110a and 110b can have the same composition or their composition may vary. Nonwoven layer 220 can include any of the bio-based polymers described above and may be formed into a nonwoven.

In the specific implementation shown in FIG. 2, nonwoven layer 220 directly contacts protective covering layers 110a and 110b. This can be accomplished by, for example, extrusion or application as a coating. Alternatively, one or more layers in between layers 220 and 110a and/or 220 and 110b may be present such as, for example, one or more adhesive, primer, or tie layers. In some embodiments, protective layers 110a and/or 110b and/or any intermediary layers between nonwoven layer 220 and a protective covering layer 110 cover the entirety of nonwoven layer 220. In some embodiments, protective layers 110a and/or 110b and/or any intermediary layers between nonwoven layer 220 and a protective covering layer 110 are not applied to the entirety of nonwoven layer 220 but only to a portion thereof.

In one exemplary implementation of this embodiment, nonwoven layer 220 is a PLA nonwoven coated on either major surface with a protective covering layer including PBS and castor wax.

The thickness of each layer shown can be any thickness required to provide the desired properties. In some embodiments, the thickness of the nonwoven layer 220 is between about 200 micrometers and about 260 micrometers. In some embodiments, the thickness of protective covering layers 110a and 110b is between about 20 to about 50 micrometers. In some embodiments, the protective covering layer 110 thickness is greater than 10, greater than 15, greater than 20, greater than 25, greater than 30, greater than 35, greater than 40, greater than 45, or greater than 50 micrometers. In some embodiments, the protective covering layer 110 thickness is less than 60, less than 55, less than 50, less than 45, less than 40, less than 35, less than 30, less than 25, or even less than 20 micrometers. The thickness of layers 110a and 110b, respectively, may be substantially the same or may differ.

### Embodiment 3

FIG. 3 shows another exemplary embodiment of an exemplary protective covering of the present disclosure. Protective covering 300 includes a cellulosic layer 330 adjacent to a protective covering layer 110 of FIG. 1. Layer 110 includes (1) a bio-based polymer and (2) a bio-based hydrophobic agent. Cellulosic layer 330 may include one or more of any type of paper such as, for example kraft paper or cardboard) or bleached paper.

In the specific implementation shown in FIG. 3, cellulosic layer 330 directly contacts protective covering layer 110. This can be accomplished by, for example, extrusion or application as a coating. Alternatively, one or more layers in between layers 330 and 110 may be present such as, for example, one or more adhesive, primer, or tie layers. In some embodiments, protective layer 110 and/or any intermediary layers between cellulosic layer 330 and protective covering layer 110 cover the entirety of cellulosic layer 330. In some embodiments, protective layer 110 and/or any intermediary layers between cellulosic layer 330 and protective covering layer 110 are not applied to the entirety of cellulosic layer 330 but only to a portion thereof.

In one exemplary implementation of this embodiment, cellulosic layer 330 is kraft paper coated on one major surface with a protective covering layer including PBS and castor wax. However, any of the cellulosic layers and/or protective coverings described herein may be used in this construction.

The thickness of each layer shown can be any thickness required to provide the desired properties. In some embodiments, the thickness of the cellulosic layer 330 is between about 140 micrometers and about 190 micrometers. In some embodiments, the thickness of protective covering layer 110 is between about 20 to about 50 micrometers. In some embodiments, the protective covering layer 110 thickness is greater than 10, greater than 15, greater than 20, greater than 25, greater than 30, greater than 35, greater than 40, greater than 45, or greater than 50 micrometers. In some embodiments, the protective covering layer 110 thickness is less than 60, less than 55, less than 50, less than 45, less than 40, less than 35, less than 30, less than 25, or even less than 20 micrometers.

### Embodiment 4

FIG. 4 shows another exemplary embodiment of an exemplary protective covering of the present disclosure. Protective covering 400 includes a cellulosic layer 330 between two protective covering layers 110a and 110b which are disposed on either major surface of cellulosic layer 330. The construction of FIG. 4 is the same as the construction of FIG. 3 except that it includes an additional protective covering layer 110 on the exposed major surface of cellulosic layer 330 of FIG. 3. As such, any of the disclosure above with respect to FIG. 3 applies equally to FIG. 4.

Protective covering layers 110a and 110b each include (1) a bio-based polymer and (2) a bio-based hydrophobic agent. Cellulosic layer 330 may include one or more of any type of paper such as, for example kraft paper or cardboard) or bleached paper.

In the specific implementation shown in FIG. 4, cellulosic layer 330 directly contacts one or more of protective covering layers 110a and 110b. This can be accomplished by, for example, extrusion or application as a coating. Alternatively, one or more layers in between layers 330 and 110a and/or 330 and 110b may be present such as, for example, one or more adhesive, primer, or tie layers. In some embodiments, protective layer 110 and/or any intermediary layers between cellulosic layer 330 and protective covering layers 110a or 110b cover the entirety of cellulosic layer 330. In some embodiments, protective layer 110 and/or any intermediary layers between cellulosic layer 330 and protective covering layer 110 do not cover the entirety of cellulosic layer 330 but only a portion thereof.

In one exemplary implementation of this embodiment, cellulosic layer 330 is kraft paper coated on either major surface with a protective covering layer including PBS and castor wax. However, any of the cellulosic layers and/or protective coverings described herein may be used in this construction.

The thickness of each layer shown can be any thickness required to provide the desired properties. In some embodiments, the thickness of the cellulosic layer 330 is between about 140 micrometers and about 190 micrometers. In some embodiments, the thickness of protective covering layer 110 is between about 20 to about 50 micrometers. In some embodiments, the protective covering layer 110 thickness is greater than 10, greater than 15, greater than 20, greater than 25, greater than 30, greater than 35, greater than 40, greater than 45, or greater than 50 micrometers. In some embodiments, the protective covering layer 110 thickness is less than 60, less than 55, less than 50, less than 45, less than 40, less than 35, less than 30, less than 25, or even less than 20 micrometers.

### Embodiment 5

FIG. 5 shows another exemplary embodiment of an exemplary protective covering of the present disclosure. Protective covering 500 includes a cellulosic layer 330 between two protective covering layers 110a and 110b. A bio-based polymeric layer 550 is between cellulosic layer 330 and protective covering layer 110a such that bio-based polymeric layer 550 is adjacent to the major surface of cellulosic layer 330, and protective covering layer 110a is adjacent to the major surface of bio-based polymer layer 550. The construction of FIG. 5 is the same as the construction of FIG. 4 except that it includes bio-based polymeric layer 550 between cellulosic layer 330 and protective covering layer 110a. As such, any of the disclosure above with respect to FIG. 4 applies equally to FIG. 5.

Protective covering layers 110a and 110b each include (1) a bio-based polymer and (2) a bio-based hydrophobic agent. Cellulosic layer 330 may include one or more of any type of paper such as, for example kraft paper or cardboard) or bleached paper. Bio-based polymeric layer 550 includes any of the bio-based polymers described herein.

In the specific implementation shown in FIG. 5, cellulosic layer 330 directly contacts protective covering layer 110b and bio-based polymeric layer 550 and bio-based polymeric layer 550 directly contacts protective covering layer 110a. This can be accomplished by, for example, extrusion or application as a coating. Alternatively, intermediary layers may be present between these layers such as, for example, one or more adhesive, primer, or tie layers. In some embodiments, layers 110a. 110b, 550, and/or any intermediary layers cover or are substantially the same as the entirety of cellulosic layer 330. In some embodiments, layers 110a, 110b, 550, and/or any intermediary layers do not cover or are not substantially the same as the entirety of cellulosic layer 330 but only cover a portion thereof.

In one exemplary implementation of this embodiment, cellulosic layer 330 is kraft paper coated on (1) a first major surface with a PBS layer that is adjacent to a protective covering layer including PBS and castor wax and (2) a second major surface with a protective covering layer including PBS and castor wax. However, any of the cellulosic layers, bio-based polymers, and/or protective coverings described herein may be used in this construction.

The thickness of each layer shown can be any thickness required to provide the desired properties. In some embodiments, the thickness of the cellulosic layer 330 is between about 140 micrometers and about 150 micrometers. In some embodiments, the thickness of the bio-based polymeric layer is between about 15 micrometers and about 40 micrometers. In some embodiments, the thickness of protective covering layer 110 is between about 20 to about 50 micrometers. In some embodiments, the protective covering layer 110 thickness is greater than 10, greater than 15, greater than 20, greater than 25, greater than 30, greater than 35, greater than 40, greater than 45, or greater than 50 micrometers. In some embodiments, the protective covering layer 110 thickness is less than 60, less than 55, less than 50, less than 45, less than 40, less than 35, less than 30, less than 25, or even less than 20 micrometers.

Any of the above constructions may include additional components including, for example, pigments and dyes including, for example, compostable or bio-based pigments and dyes. Exemplary compostable pigments and dyes include PLA masterbatch colorings available from Clariant Corp. (Minneapolis, MN, USA) under the OM or OMB lines of products, or those available from Techmer PM LLC (Clinton, TN, USA) under the PLAM or PPM lines of products. Typically, when colorings are employed, they are blended with the other coating components at an amount of 0.5%-5% by weight.

In some embodiments, an optional layer is added to improve/lower the oxygen transmission rate (OTR). Some exemplary such layers include polyvinyl alcohol (PVOH) or ethylene vinyl alcohol (EVOH).

The embodiments of FIGS. 2-5 include multiple layers. Any known method of forming these multi-layer constructions may be used including, for example, extrusion of one layer onto another layer and/or coating one layer with another layer. It is possible to use a combination of the foregoing two approaches in any embodiment of the articles described herein. In some embodiments, the adjacent layers may be completely overlapping in surface area. In other embodiments, the adjacent layers are only partially overlapping in surface area (i.e., a coating need not be applied to the entirety of the base layer or sheet, but can be on only part of the base layer or sheet).

In some embodiments, one or more protective covering layers are embossed. In some embodiments, the protective covering is embossed. In some embodiments, one of the protective covering or a protective covering layer includes projections or posts, as is described in U.S. Patent Application No. 63/011,024, (Matter No. 82723US002) assigned to the present assignee.

### Exemplary Phase Change Materials

PCMs for use in the constructions of the present disclosure maintain the desired temperature of an article to be transported during shipment. As such, the one or more PCMs may have one or more of the following qualities: fine tunability over a wide range of physical properties; resilient to temperature and jostling during shipping; freezing without much supercooling; ability to melt congruently; compatibility with a variety of conventional materials; chemical stability; non corrosive; non-flammable; and nontoxic. In some embodiments, the PCM(s) are compostable and/or biobased. The PCM may take the form of a liquid, gel, hydrocolloid, or three-dimensional shape (e.g., a rectangle, square, or brick).

Some exemplary PCMs are as follows. Suitable PCMs may be organic or inorganic materials, including salts, hydrated salts, fatty acids, paraffins, and/or mixtures thereof. Because different phase change materials means for changing phases undergo phase change (or fusion) at various temperatures, the particular material that is chosen for use in the device may depend on the temperature at which the packaging is desired to be kept, which may include ranges between from about −135° C. to about 40° C. The desired range within this range may depend on the intended use of the packaging. For example, food cold chain packaging is typically between about −36° C. to about 25° C. Biologic or pharmaceutical cold chain packaging is typically between about −135° C. to about 40° C.

In some embodiments used for a cold chain, an approximately 20-23 weight percent salt solution comprising sodium chloride and water may be provided as the phase change material. This particular phase change material is characterized by a phase change temperature of fusion of from about −19° C. to about −21° C. Such temperature range may be suitable for use with the packaging and shipment of many pharmaceutical products, such as drugs, vaccines, and other active biologics.

Other exemplary phase change materials or means for changing phases useable in the present cold chain packaging, devices, and articles may include compositions produced in accordance with the process as described in U.S. Pat. No. 6,574,971, that have the desired phase change temperature and other characteristics described above. The materials of U.S. Pat. No. 6,574,971 include fatty acids and fatty acid derivatives made by heating and catalytic reactions, cooling, separating and recirculating. The reactant materials include a fatty acid glyceride selected from the group consisting of oils or fats derived from soybean, palm, coconut, sunflower, rapeseed, cotton seed, linseed, caster, peanut, olive, safflower, evening primrose, borage, carboseed, animal tallows and fats, animal greases, and mixtures thereof. In accordance with the processes of U.S. Pat. No. 6,574,971, the reaction mixture is a mixture of fatty acid glycerides that have different melting points and the reaction is an interesterification reaction, or the reaction mixture includes hydrogen and the reaction is hydrogenation, or the reaction mixture is a mixture of fatty acid glycerides and simple alcohols and the reaction is an alcoholysis reaction.

Additional exemplary PCMs include those listed in the following documents: U.S. Pat. Nos. 9,850,415; 9,914,865; 10,119,057; and 10,745,604, each of which is incorporated by reference in their entirety herein.

### Exemplary Packaging Containers

The packaging constructions of the present disclosure protect the article being transported during transport and maintain the article at a constant desired temperature. The packaging devices, containers, and constructions described herein include one or more protective coverings described herein and one or more PCMs described herein. The packaging devices, constructions, or containers of the present disclosure may have one or more of the following characteristics.

In some embodiments, the packaging devices, containers, or constructions are compostable and/or biobased.

In some embodiments, the packaging devices, containers, or constructions have a high thermal insulation R value. A thermal insulation R value can be provided in SI units of Km²/W (aka RSI) or in imperial (US) units of ft²·° F.·h/BTU. A thermal insulation (US) R value per inch of at least 2, or 5, or higher is preferred, dictated by the temperature requirements and time duration desired. A thermal insulation (US) R value per inch is between about 2 and about 8 for EPS, PET, PUR type insulation with Aerogels having (US) R-values in the R-10 to R-30 range per inch and Vacuum Insulated Panels (VIP) with (US) R-values that can often exceed 40 and as be as high as 60 per inch.

In some embodiments, the packaging devices, containers, or constructions have dimensional stability, which refers to the protective covering or packaging container has at least one dimension which decreases by no greater than 10% in the plane of the material or nonwoven when heated to a temperature at or within 15° C. or 20° C. above a glass transition temperature of the fibers of the fabric while in an unrestrained condition.

In some embodiments, the packaging devices, containers, and constructions have sufficient strength to maintain the integrity of the package during shipment. A packaging container may be dropped, jostled, or otherwise subjected to blunt forces during shipment and thus the packaging is preferably strong enough with withstand such forces.

The packaging devices, containers, and constructions and/or protective covering should be useful in a wide range of temperatures (as disclosed herein) and conditions, including a variety of humidity conditions. The packaging devices, containers, and constructions should be able to withstand freezing/thawing and should be able to withstand limited amounts of rain and liquid spillage that may occur during shipping/transport.

Within a typical vaccine cold chain, vaccines are packaged into individual vials which in turn are bundled together in inner packs for transport. They often include even larger groupings of cold boxes and vaccine carriers as well. PCMs are typically incorporated in sealed pouches to form PCM pillows. Prior to wrapping PCM pillows intimately around the inner packs or cold boxes and vaccine carriers, they are pre-conditioned in refrigerator or freezers to the desired temperatures for duration of transportation. Depending upon the cold chain transportation requirements, insulation material such as PET fibers, Styrofoam pallets, Aerogels, polyurethane (PUR), phenolic foam insulations, expanded polystyrene (EPS) foam or vacuum insulated panels (VIP) is often employed.

The packaging container may be any desired shape, size, or construction. Some exemplary constructions include mailers, envelopes, bags, boxes, and pouches. In some states, the packaging construction includes an opening through which the article to be shipped passes when placed in the packaging container. In some states, the packaging container is fully sealed and closed after placement of the article to be shipped within the packaging container. The packaging constructions of the present disclosure may also include one or more mechanisms or features to facilitate easy opening of the packaging article after it is sealed. Exemplary features include perforations, scoring, zip-tops, embedded pull-strings, wires, or combinations thereof. When an opening or flap is present, one or more of these features may be present near the opening or flap to facilitate opening the packaging article near the opening or flap, or they may be present on a different part of the packaging article. While these features, when employed, are most commonly in a straight line parallel to at least one edge of the packaging article no particular configuration is required; other shapes or layouts can be used depending on the intended use of the packaging article.

Some embodiments of the packaging construction further include an insulating material such as, for example, a foam (open or closed cell), aerogel, cardboard, urethane, expanded polystyrene, and/or fabric loaded with foam or aerogel.

### Exemplary Methods of Making

An exemplary method of forming a cold chain packaging, article, or device as described herein involves (1) providing a PCM with the desired properties; (2) providing a protective covering with the desired properties; (3) placing the PCM and protective covering adjacent to one another; and (4) forming a shipping container, article, or device. These steps are not intended to be restricted to the particular order recited. Other associated steps may be included. Furthermore, the steps may be performed in multiple parts and at multiple different times.

The method of forming the shipping container, article, or device will depend on what design and style of shipping container, article, or device is desired. Pouches and envelopes can be formed as described in U.S. Patent Application Publication Nos. US/20160229622, US/20190226744, US/20090230138; bags can be formed as described in U.S. Pat. No. 6,412,545 and Korean Patent No. 20-0492210; boxes can be formed as described in U.S. Patent Application Publication No US/20200317423; PCT Patent Application Publication No. WO/2017048793; U.S. Pat. Nos. 10,501,254; 9,376,605; 10,451,335; 9,950,851; and 9,429,350.

### Exemplary Methods of Using

The packaging devices and constructions described herein can be used in a wide array of ways. They can be used to ship any item. In some embodiments, they can be used to ship or package temperature-sensitive items. In some embodiments, they can be used to ship or package food, biologics, or medication including, but not limited to, vaccines.

The following examples describe some exemplary constructions of various embodiments of the cold chain packaging, articles, and devices of the present disclosure. The following examples describe some exemplary constructions and methods of constructing various embodiments within the scope of the present application. The following examples are intended to be illustrative, but are not intended to limit the scope of the present application.

### EXAMPLES

Unless otherwise noted or readily apparent from the context, all parts, percentages, ratios, etc. in the Examples and the rest of the specification are by weight.

Materials Used in the Examples

| Abbreviation | Description and Source |
|---|---|
| BioPBS FZ71-PB | Poly butylene succinate from PTT MCC Biochem Company Ltd, |
| | Bangkok, Thailand. |
| BioPBS FZ91-PB | Poly butylene succinate from PTT MCC Biochem Company Ltd, |
| | Bangkok, Thailand. |
| BioPBS FD92-PB | Poly butylene succinate from PTT MCC Biochem Company Ltd, |
| | Bangkok, Thailand. |
| INGEO 6202D | 25 grams per square meter spun bond polylactide from |
| | NatureWorks LLC, Minnetonka, MN (USA), under trade |
| | designation “INGEO BIOPOLYMER 6202D”. |
| CASTORWAX MP-80 | Castor Wax MP-80 from Vertellus, Indianapolis, IN (USA), under |
| | trade designation “CASTORWAX MP-80”. |
| PLAM 69962 | PLA green masterbatch from Techmer PM LLC, Clinton, TN |
| | (USA). |
| OM9364251 | PLA black masterbatch from Clariant Corporation, Minneapolis, |
| | MN (USA). |
| OM0364246 | PLA white masterbatch from Clariant Corporation, Minneapolis, |
| | MN (USA). |
| Kraft paper | 45-lb Kraft paper from Ahlstrom-Munksjo, Helsinki, Finland. |
| Kraft paper-2 | 55-lb Kraft paper from Ahlstrom-Munksjo, Helsinki, Finland. |
| Bleached paper | 66-lb bleached paper from LOPAREX, Hammond, WI (USA). |

### General Method for Forming Protective Coverings-I:

Protective coverings according to the Examples described below were formed via a melt extrusion process using a 58-millimeter (mm) twin screw extruder (Model DTEX58t, obtained from Davis-Standard, Pawcatuck, CT), operated at a 260° C. extrusion temperature, with a heated hose (260° C.) leading to a 760 mm drop die (obtained from Cloeren Inc., Orange, TX) with 686 mm deckles: 0-1 mm adjustable die lip, single layer feed-block system. Solid feed coating material was fed at a rate of 50 pounds per hour (22.7 kilograms per hour) into the twin screw system at the conditions described above. The resultant molten resin formed a thin sheet as it exited the die and was cast directly into a nip of two rolls. The surface roughness of the steel roll was set at 75 Roughness Average by use of a sleeve (American Roller Company, Union Grove, WI) against the cast film side, and a silicone rubber nip roll (80-85 durometer; from American Roller Company, Union Grove, WI) was set against the other side of the film melt. The film melt was pressed between the two nip rolls with a nip force of about 70 kilopascals (kPa), at a line speed that was adjusted to provide the desired coating thickness. In an alternative method, once the melt left the die, it was laminated to a substrate (e.g., paper, or nonwoven material) via a nip system as described above. If the protective covering was to be applied on both opposed major surfaces of the substrate, then the coating step was repeated in a second step.

### General Method of Forming Protective Coverings-II:

Protective coverings according to the Examples described below were formed via a melt extrusion process. The solid feed protective covering material was air conveyed and flood fed into the throat of a 6.5 inch (16.5 cm) diameter single screw extruder. The feed protective covering material was melted and pumped through the head of the extruder through a short pipe adaptor into the feed block of a 93 inch (2.36 m) wide single manifold die (obtained from Cloeren Inc., Orange, TX). Adjustable deckles were used to adjust effective coating width to 3-4 inch (7.6-10.1 cm) past carrier liner on each side of the system. The die utilized an adjustable die lip gapped to 25 mils (0.63 mm) as an initial starting point, then was adjusted manually or via the autoflex system to obtain a flat cross web caliper. Once the melt left the die, it was laminated to a major surface of a substrate (e.g., paper) via a nip system in the coating station. The nip roll was 18 inch (45.7 cm) in diameter with an 85-durometer silicone rubber sleeve and was pressed using pneumatic cylinders against the coating roll at 115 psi (792 kPa). The coating roll was 42 inch (1 m) diameter with a 125 Ra surface finish and chilled to 55° F. (13° C.) using recirculating chilled water. As the protective coated material exited the coating roll, two edge trimmers cut the overcoated polymer to give a clean edge. The protective covering then went through a web flip before being reintroduced to a second coating station matching the first to coat the other opposed major surface of the substrate. Prior to the substrate (e.g., paper) passing into the casting station, it was subjected to a corona discharge plasma set at 15 kW across three differing electrodes to promote bonding between the protective covering and the major surface of the substrate.

General Method of Making Pouches from Protective Coverings:

The protective coverings prepared as described in Examples described below were used to make pouches that can be filled with phase change materials (PCMs). The pouches were made using a manual impulse sealer (Model H-458, obtained from Uline, Pleasant Prairie, WI). Approximately 6 inch×16 inch (15 cm×41 cm) wide of protective coating material was folded in half having the coated side on the inside, then the edges of the folded web were heat sealed using the same impulse sealer to create approximately 6 inch×8 inch (15 cm×20 cm) pouches.

### Method for Testing Seam Strength:

The seam strength of pouches made using the General Method of Making Pouches from Protective Coverings was determined using the procedures outlined in ASTM F88/F88M-15 (approved Nov. 1, 2015, Published December 2015), “Standard Test Method for Seal Strength of Flexible Barrier Materials.” Test specimens 2.5 cm (1 in) wide were cut from the pouches perpendicular to the seam, with a length of at least 5.1 cm (2 in) of material on either side of the seam. Samples were conditioned overnight in a controlled temperature and humidity room at 22.8±1.1° C. (73.1±2° F.) and 50±2% relative humidity prior to testing. Specimens were loaded into a constant-rate-of-extension tensile tester (Model MTS ALLIANCE RT/50 TESTING MACHINE, obtained from MTS Systems Corporation, Eden Prairie, MN) with a 1000 N load cell at an initial jaw separation of 3.8 cm (1.5 in). The sample was pulled until seam separation using an extension rate of 25 cm/min (10 in/min), and the average peak load and total energy of six specimens per sample were recorded. The seam width was measured, and the scam strength was calculated as the peak load divided by the scam width.

### Method for Tensile Test:

Tensile strength, % elongation at break, and 1% secant modulus of protective coverings made according to the Examples described below were determined using the procedures described in ASTM D-882-18 (Revision Aug. 16, 2018), “Test Method for Tensile Properties of Thin Plastic Sheeting.” For these tests a pull speed of 10 in/min (25 cm/min) was used, and samples were tested in both the machine direction (MD) and the cross-web (transverse) direction (CD).

### Method for Elmendorf Tear Resistance Test:

Elmendorf tear resistance of protective coverings made according to the Examples described below were determined using the procedures described in ASTM D-1922-15 (Revision Apr. 14, 2020), “Test Method for Propagation Tear Resistance of Plastic Film and Thin Shecting by Pendulum Method”. The samples were tested in both the machine direction (MD) and the cross-web (traverse) direction (CD). These tests were intended to provide reference data for the materials in Examples 5 thru 8 as compared to uncoated paper, which does not work satisfactorily.

### Method for Puncture/Impact Resistance Test:

Puncture/Impact resistance of protective coverings made according to the Examples described below were determined using the procedures described in ASTM D-1709-16a, “Test Methods for Impact Resistance of Plastic Film by the Free-Falling Dart Method” (Method A).

### Method for Freeze/Thaw Test:

The pouches made using the General Method of Making Pouches from Protective Coverings were tested by filling them with 230 mL of a phase change material (PCM) (obtained from Pure Temp LLC, Minneapolis, MN, under trade designation PURE TEMP 4N ORANGE). The filled pouches were sealed and left in room temperature overnight to check for leakage. No leaks were observed. Then the sealed pouches were placed in a freeze/thaw chamber set at −17.8° C. The pouches were conditioned at −17.8° C. for 24 hours and then thawed out to room temperature. The thawed pouches were visually inspected for leakage.

### Example 1

The protective covering of Example 1 was a film similar to Embodiment 1 shown in FIG. 1. The protective covering of Example 1 was prepared using the General Method for Forming Protective Coverings-I described above. The Example 1 protective covering was a film having a thickness of 152 micrometers and a composition of 95 wt. % BioPBS FZ91-PB and 5 wt. % CASTORWAX MP-80.

### Example 2

The protective covering of Example 2 was similar to the Embodiment 2 shown in FIG. 2. The protective covering of Example 2 was prepared by coating an INGEO 6202D nonwoven material on both opposed major surfaces with a protective covering using the General Method for Forming Protective Coverings-I described above. The protective covering on the first major surface of INGEO 6202D nonwoven material was 37 micrometers thick and had a composition of 99 wt. % BioPBS FZ71-PB and 1 wt. % PLAM 69962. The protective covering on the second opposed major surface of INGEO 6202D nonwoven material was 37 micrometers thick and had a composition of 95 wt. % BioPBS FZ71-PB, 5 wt. % OM0364246, and 1 wt. % OM9364251.

### Example 3

The protective covering of Example 3 was similar to the Embodiment 3 shown in FIG. 3. The protective covering of Example 3 was prepared by coating one major surface of a Kraft paper (45-lb basis weight) with a protective covering using the General Method for Forming Protective Coverings-I described above. The protective covering on the Kraft paper surface was 30 micrometers thick and had a composition of 95 wt. % BioPBS FZ191-PB and 5 wt. % CASTORWAX MP-80.

### Example 4

The protective covering of Example 4 was similar to Embodiment 4 shown in FIG. 4. The protective covering of Example 4 was prepared by coating a bleached paper on both opposed major surfaces with a protective covering using the General Method for Forming Protective Coverings-II described above. The protective covering on both opposed major surfaces of the bleached paper was 37 micrometers thick and had a composition of 100 wt. % BioPBS FZ71-PB.

### Example 5

The protective covering of Example 5 was a film similar to Embodiment 3 shown in FIG. 3. The protective covering of Example 5 was prepared by coating one major surface of a Kraft paper-2 with a protective covering using the General Method for Forming Protective Coverings-I described above. The Example 5 protective covering was a film having a thickness of 8.4 micrometers and having a composition of 50 wt. % BioPBS FD92-PB and 50% by weight of the compound of 95 wt. % FZ91 with 5 wt. % CASTORWAX MP-80. For this material, 1 micrometer of thickness translates to 7.14 g/m² (7.14 gsm), so the coating weight was 60 gsm.

### Example 6

The protective covering of Example 6 was a film similar to Embodiment 3 shown in FIG. 3. The protective covering of Example 6 was prepared by coating one major surface of a Kraft paper (45-1b basis weight) with a protective covering using the General Method for Forming Protective Coverings-I described above. The Example 6 protective covering was a film having a thickness of 8.4 micrometers and having a composition of 50 wt. % BioPBS FZ91-PB and 50 wt. % of the compound of 95 wt. % FZ91 with 5 wt. % CASTORWAX MP-80.

### Example 7

The protective covering of Example 7 was a film similar to Embodiment 3 shown in FIG. 3. The protective covering of Example 7 was prepared by coating one major surface of a Kraft paper-2 (55-lb basis weight) with a protective covering using the General Method for Forming Protective Coverings-I described above. The Example 7 protective covering was a film having a thickness of 11.2 micrometers (80 gsm) and having a composition of 50 wt. % BioPBS FZ91-PB and 50 wt. % of the compound of 95 wt. % FZ91 with 5 wt. % CASTORWAX MP-80.

### Example 8

The protective covering of Example 8 was a film similar to Embodiment 3 shown in FIG. 3. The protective covering of Example 8 was prepared by coating one major surface of a nonwoven (INGEO 6202D) with a protective covering using the General Method for Forming Protective Coverings-I described above. The Example 8 protective covering was a film having a thickness of 4.2 micrometers (30 gsm) and having a composition of 50 wt. % BioPBS FZ91-PB and 50% by weight of the compound of 95 wt. % FZ91 with 5 wt. % CASTORWAX MP-80.

The protective coverings of Examples 2-4 were tested using the test methods described above. The results of the tests are summarized below in Table 1.

TABLE 1
Tensile and Elongation Results for Examples 2-4

| | | | | Tensile & Elongation Data | | | |
|---|---|---|---|---|---|---|---|
| | | Puncture | Elmendorf | 1% Secant | Tensile | | Strength @ |
| | | Break | Tear Force | Modulus | Strength | Elongation | Peak Load |
| | | (N) | (N) | (MPa) | (N/m²) | % | (MPa) |
| Ex. 2 | MD | 15.26 | 1.4 | 4.31 | 3.84 × 10⁶ | 23.94 | 0.39 |
| | CD | | 2.1 | 3.92 | 6.75 × 10⁶ | 31.12 | 0.69 |
| Ex. 3 | MD | 10.72 | 0.8 | 3,504.66 | 2.52 × 10⁷ | 2.33 | 56.36 |
| | CD | | 1.1 | 1,285.16 | 9.96 × 10⁶ | 1.14 | 21.55 |
| Ex. 4 | MD | 19.28 | 2.4 | 1,744.38 | 3.0 × 10⁷ | 3.67 | 3.04 |
| | CD | | 2.5 | 984.32 | 1.18 × 10⁷ | 6.15 | 1.84 |

The protective coverings of Examples 5-8 were tested using the test methods described above. The results of the tests are summarized below in Tables 2 and 3.

TABLE 2
Puncture/Impact Test, Seam Strength, and
Freeze/Thaw Test Results for Examples 5-8

| | Puncture/Impact Test | | Seam Strength Test | | |
|---|---|---|---|---|---|
| | Peak | Energy/Aₒ to | Tear | Peel Peak | |
| | Load | Peak | Energy | Load | Freeze/Thaw |
| Example | (N) | (N · m/cm²) | (J/m) | (N) | Test |
| 5 | 24.70 | 0.94 | 215.9 | 34.96 | No leakage |
| 6 | 19.43 | 0.74 | 20.7 | 31.14 | No leakage |
| 7 | 24.58 | 1.22 | 301.6 | 72.46 | No leakage |
| 8 | 27.60 | 3.94 | 15.9 | 8.59 | No leakage |

TABLE 3
Tensile Strength Results for Examples 5-8

| | | | Tensile Test | | |
|---|---|---|---|---|---|
| | | Elmendorf | | % Elongation | Break |
| | Test | Tear Force | Modulus | at Break | Strength |
| Example | Direction | (MPa) | (MPa) | (%) | (MPa) |
| 5 | CD | 1.15 | 1,329.11 | 4.97 | 23.46 |
| | MD | 0.94 | 3,250.29 | 2.53 | 42.46 |
| 6 | CD | 0.85 | 1,513.60 | 5.40 | 28.43 |
| | MD | 0.70 | 2,631.34 | 2.70 | 38.04 |
| 7 | CD | 1.06 | 2,698.63 | 3.10 | 41.78 |
| | MD | 1.24 | 1,422.22 | 4.57 | 24.02 |
| 8 | CD | 2.33 | 268.82 | 41.90 | 9.60 |
| | MD | 1.62 | 534.12 | 29.17 | 18.02 |

In this document, the terms “a” or “an” are used, as is common in patent documents, to include one or more than one, independent of any other instances or usages of “at least one” or “one or more.”

In this document, the term “or” is used to refer to a nonexclusive or, such that “A or B” includes “A but not B,” “B but not A,” and “A and B,” unless otherwise indicated.

In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim.

The recitation of all numerical ranges by endpoint is meant to include all numbers subsumed within the range (i.e., the range 1 to 10 includes, for example, 1, 1.5, 3.33, and 10).

The terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

In the event of inconsistent usages between this document and any documents so incorporated by reference, the usage in this document controls.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention can be determined with reference to the appended claims, along with the full scope of equivalents to which such claims are entitled.

Those having skill in the art will appreciate that many changes may be made to the details of the above-described embodiments and implementations without departing from the underlying principles thereof. Further, various modifications and alterations of the present disclosure will become apparent to those skilled in the art without departing from the spirit and scope of the disclosure. The scope of the present application should, therefore, be determined only by the following claims and equivalents thereof.

1. A packaging article, comprising:
one or more phase change materials (PCMs);
a protective covering adjacent to the one or more PCMs; the protective covering comprising a bio-based polymer and a bio-based hydrophobic agent.

2. The packaging article of claim 1, wherein the one or more PCMs are one or more of the following:

3. The packaging article of claim 1, wherein the bio-based polymer is at least one of polybutylene succinate (PBS), poly(lactic acid) (which is sometimes known as PLA, and as used herein is intended to encompass both poly(lactic acid) and poly(lactide)), poly(glycolic acid) (which as used herein is intended to encompass both poly(glycolic acid) and poly(glycolide)), poly(caprolactone), poly(lactide-co-glycolide), copolymers of two or more of lactic acid, glycolic acid, and caprolactone, polyhydroxyalkanoate (PHA), polyester urethane, degradable aliphatic-aromatic copolymers, poly(hydroxybutyrate) (PHB), copolymers of hydroxybutyrate and hydroxy valerate, poly(ester amide), polyhydroxy hexanoate (PHH), cellulosic ester, and cellulose.

4. The packaging article of claim 1, wherein at least 5 weight percent of the protective covering is the bio-based polymer.

5. The packaging article of claim 1, wherein the bio-based hydrophobic agent is at least one of ethylene bis(stearamide) (EBS), castor wax, polyamitic acid, lionol leic acid, arachahdoric acid, polantolic acid, butric acid, steric acid, hydroxy stearates, amine derivatized hydroxy stearates and triglyceride.

6. The packaging article of claim 1, wherein less than 15 weight percent of the protective covering is the bio-based hydrophobic agent.

7. The packaging article of claim 1, wherein the protective covering further comprises:
a cellulosic material.

8. The packaging article of claim 1, further comprising:
an insulative material.

9. The packaging article of claim 1, wherein the protective covering has a tensile strength of between about 1.0×10⁵ N/m² to about 9.0×10⁷ as measured according to ASTM D882.

10. The packaging article of claim 1, wherein the protective covering has a thickness that is between about 100 micrometers and about 250 micrometers.

11. The packaging article of claim 1, having a thermal insulation (US) R value per inch of at least 2 RSI.
